(19) United States
(12) Patent Application Publication
(10) Pub. No.: US 2025/0066513 A1
(43) Pub. Date: Feb. 27, 2025

(54) Catalyst System For Enhanced Stereo-Specificity Of Olefin Polymerization

(71) Applicant: Formosa Plastics Corporation, U.S.A., Livingston, NJ (US)

(72) Inventors: Lei Zhang, Port Lavaca, TX (US); Gapgoung Kong, Sugerland, TX (US); Chih-Jian Chen, Port Lavaca, TX (US); Cyrus C. Y. Lee, Victoria, TX (US); Guangxue Xu, Port Lavaca, TX (US)

(21) Appl. No.: 18/454,227

(22) Filed: Aug. 23, 2023

(51) Int. Cl. C08F 4/76

(52) U.S. Cl. CPC C08F 4/76

(57) ABSTRACT

A preparation method to produce a Ziegler-Natta catalyst for olefin polymerization through treatment of MgCl₂.xROH adduct with a transition metal halide in the presence of one or more urea compounds in combination with one or more internal electron donors is provided. The catalyst systems, according to present invention, are able to produce polypropylene polymers with higher stereo-regularity. The catalyst systems, according to present invention, are able to produce polypropylene polymers using a phthalate-free catalyst system, with an isotacticity that is equal to or higher than catalyst systems containing phthalate derivatives.

### BACKGROUND

The present invention relates to a preparation method to produce a Ziegler-Natta catalyst for olefin polymerization through treatment of MgCl₂.xROH adduct with a transition metal halide in the presence of one or more urea compounds in combination with one or more internal electron donors, and to the polymerization processes for producing polyolefins, particularly polypropylene, which exhibits substantially higher stereo-regularity.

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. The Ziegler-Natta catalyst components comprise magnesium, halide, titanium and internal electron donor compounds which have been widely employed to increase the activity and stereo-specificity of polymerization catalyst system.

Common internal electron donor compounds, which are incorporated in the solid Ziegler-Natta catalyst component during preparation of such component, are known in the art and include organic acid esters, ethers, ketones, amines, alcohols, heterocyclic organic compounds, phenols, phosphines, and silanes. It is well known in the art that polymerization activity, as well as stereo-regularity, molecular weight, and molecular weight distribution of the resulting polymer depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818;6,121,483; 6,281,301; 6,294,497; 6,313,238; 6,395,670,6,436,864, 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290 8,569,195; 8,575,283; 8,604,146; 8,633,126; 8,692,927; 8,664,142; 8,680,222; 8,716,514; and 8,742,040, which are incorporated by reference herein in their entireties.

In the utilization of Ziegler-Natta type catalysts for polymerizations involving propylene or other olefins for which isotacticity is a possibility, it may be desirable to utilize an external electron donor, and acceptable external electron donors include organic compounds containing O, Si, N, S, and/or P. Such compounds include organic acids, organic acid esters, organic acid anhydrides, ethers, ketones, alcohols, aldehydes, silanes, amides, urea, amines, amine oxides, thiols, various phosphorus acid esters and amides, etc. Preferred external electron donors are organosilicon compounds containing Si—O—C and/or Si—N—C bonds, having silicon as the central atom. Such compounds are described in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,614,162; 8,648,001; and 10,655,494, which are incorporated by reference herein.

Most commercial propylene polymerization catalysts currently employ alkyl phthalate esters as an internal electron donor. But still there is a need to further improve stereo-regularity of catalyst components employing alkyl phthalate esters as an internal donor for the application of polypropylene polymer to impact copolymer area. Moreover, certain environmental issues have been recently raised concerning the continued use of phthalate derivatives in human contact applications. As a result, the employment of a phthalate-free propylene polymerization catalyst is now necessary for the production of polypropylene to remedy these issues. U.S. Pat. No. 7,491,781 teaches the use of an internal electron donor in a propylene polymerization catalyst component which does not contain a phthalate derivative. However the resultant propylene polymerization catalyst produced polypropylene with lower isotacticity than that of a catalyst containing a phthalate derivative.

As such, there is a need of development for a catalyst system containing phthalate derivatives as internal electron donors that can produce polypropylene with further higher isotacticity. Even more desirable is the development of a phthalate-free catalyst system capable of producing polypropylene with an isotacticity that is equal to or better than systems that contain only phthalate derivatives.

Isotacticity modifiers have been used as a catalyst component in a phthalate-based or phthalate-free catalyst system to produce polypropylene polymers with improved stereo-regularity. U.S. Pat. Nos. 9,593,184; 9,777,084; 9,815,920; and 10,124,324 teach the use of an amide compound and a urea compound as isotacticity modifiers in the preparation of Ziegler-Natta catalysts through the reaction of magnesium ethoxide with Titanium chlorides.

There have been reported so far many Ziegler-Natta catalyst preparation methods. Among them, a magnesium compound solution is often used in order to control the shape or size of a catalyst. One common method for obtaining such a solution is to treat a magnesium compound with an alcohol, as disclosed in U.S. Pat. Nos. 4,330,649 and 5,106,807. The commonly used MgCl₂.xROH adduct can be suitably prepared in spherical form by mixing magnesium chloride and an alcohol in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Examples of spherical adducts prepared according to this procedure are described in U.S. Pat. Nos. 4,399,054 and 4,469,648. The solid catalyst component can then be prepared by reacting a transition metal halide with spherical MgCl₂.xROH adduct, as taught in U.S. Pat. Nos. 6,395,670, 6,716,939, 9,522,968, and 10,287,371. With the good control of catalyst morphological properties, further improvement in stereo-regularity of the obtained polymers will increase the commercial value of such catalysts.

### SUMMARY OF THE INVENTION

A preparation method to produce a Ziegler-Natta catalyst for olefin polymerization through treatment of MgCl₂.xROH adduct with a transition metal halide in the presence of one or more urea compounds in combination with one or more internal electron donors is provided. The catalyst systems, according to present invention, are able to produce polypropylene polymers with higher stereo-regularity. The catalyst systems, according to present invention, are able to produce polypropylene polymers using a phthalate-free catalyst system, with an isotacticity that is equal to or higher than catalyst systems containing phthalate derivatives.

The present invention provides a method of preparing a Ziegler-Natta catalyst system producing polypropylene with enhanced isotacticity, wherein the catalyst is prepared through treatment of MgCl₂.xROH adduct with a transition metal halide in the presence of one or more internal electron donors, and one or more urea compounds represented by Formula I:

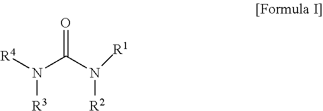

wherein R¹, R², R³, and R⁴, which may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms, wherein two or more of R¹, R², R³, and R⁴ may be linked to form one or more saturated or unsaturated monocyclic or polycyclic rings.

### DESCRIPTION OF PREFERRED EMBODIMENTS

In accordance with certain embodiments of the present invention, a specific class of urea compounds employed as an element of solid Ziegler-Natta catalyst components in conjunction with one or more internal donors, for the production of polyolefins, particularly polypropylene, are disclosed. The urea compounds of the present invention may be used in combination with one or more internal electron donors that are typically employed in Ziegler-Natta polypropylene catalyst systems such as diethers, malonates, succinates, phthalic acid esters, esters of aliphatic or aromatic diols, or their derivatives.

According to certain aspects of the present invention, a preparation method for a Ziegler-Natta catalyst for the polymerization of olefins is provided, which comprises the steps of: (1) treating MgCl₂.xROH adduct with a transition metal halide in a reactor at a temperature of between about −30° C. and about 30° C.; (2) adding an internal electron donor and an urea compound at the same or different temperature between about 0° C. and about 100° C.; (3) heating the resulting mixture to at least about 80° C. and holding the resulting mixture at that temperature for about 1 to 3 hours to produce a pre-catalyst; (4) after siphoning, treating the pre-catalyst with a transition metal halide at a temperature of at least 90° C. for about 0.5 to 3 hours to form a catalyst, and optionally repeating this step for 1 to 3 times; (5) washing the catalyst with a hydrocarbon solvent and optionally drying the catalyst.

In the step (1), the catalyst support magnesium chloride is derived from an adduct of formula MgCl₂.xROH, wherein x is preferably in the range of from about 1 to about 4, more preferably from 2 to 3.5, and ROH is an alcohol or a mixture of alcohols where R is a hydrocarbon radical with 1-10 carbon atoms.

Transition metal halides useful in the step (1) are represented by the general formula M(OR)ₙX₍₄₋ₙ₎, wherein R is an alkyl group having 1-10 carbon atoms, X is a halogen atom, and n is an integer of 0-3. Among them, a titanium compound containing halogen is preferably used. Particularly, titanium tetrachloride is more preferably used. Also, mixtures of two or more such transition metal halides may be used.

Further, in the step (1), the treatment temperature is preferably between −30° C. and 30° C., and more preferably between −10° C. and 10° C. When the treatment temperature is higher than 30° C., the control of the catalyst particle shape becomes difficult.

Urea compounds that may be employed as an element of catalyst composition in conjunction with internal donors in the step (2) are represented by Formula I:

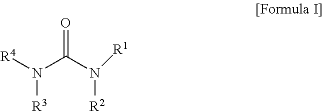

wherein R¹, R², R³, and R⁴ may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms, wherein two or more of R¹, R², R³, and R⁴ may be linked to form one or more saturated or unsaturated monocyclic or polycyclic rings.

Preferred examples of suitable urea compounds of the Formula I include, but are not limited to: N,N,N′, N′-tetramethylurea, N,N,N′,N′-tetraethylurea, N,N,N′,N′-tetrapropylurea, N,N,N′,N′-tetrabutylurea, N,N,N′,N′-tetrapentylurea, N,N,N′, N′-tetrahexylurea, N,N,N′,N′-tetra(cyclopropyl)urea, N,N,N′,N′-tetra(cyclohexyl)urea, N,N,N′,N′-tetraphenylurea, bis(butylene)urea, bis(pentylene)urea, N,N′-dimethylethyleneurea, N,N′-dimethylpropyleneurea, N,N′-dimethyl(2-(methylaza)propylene)urea and N,N′-dimethyl(3-(methylaza)pentylene)urea, n-amyltriphenylurea, n-hexyltriphenylurea, n-octyltriphenylurea, n-decyltriphenylurea, n-octadecyltriphenylurea, n-butyltritolylurea, n-butyltrinaphthylurea, n-hexyltrimethylurea, n-hexyltriethylurea, noctyltrimethylurea, dihexyldimethylurea, dihexyldiethylurea, trihexylmethylurea, tetrahexylurea, n-butyltricyclohexylurea, t-butyltriphenylurea, 1,1-bis(p-biphenyl)-3-methyl-3-n-octadecylurea, 1,1-di-n-octadecyl-3-1-butyl-3-phenylurea, 1-p-biphenyl-1-methyl-3-noctadecyl 3 phenylurea, 1-methyl-1-n-octadecyl-3 p-biphenyl-3-o-tolylurea, m-terphenyl-tri-t-butylurea, 1,3-dimethyl-2-imidazolidinone, 1,3-diethyl-2-imidazolidinone, 1,3-dipropyl-2-imidazolidinone, 1,3-dibutyl-2-imidazolidinone, 1,3-dimethyl-3,4,5,6-tetrahydro-2-pyrimidinone, and N,N-dimethyl-N,N,-diphenylurea.

The acceptable internal electron donor compounds in the step (2) include, but are not limited to one or more internal electron donors that are typically employed in Ziegler-Natta polypropylene catalyst system such as diethers, malonates, succinates, phthalic acid esters, esters of aliphatic or aromatic diols, or their derivatives.

Examples of phthalic acid esters that can be used in in the step (2) include, but are not limited to: diethylphthalate, di-n-propylphthalate, di-n-butylphthalate, di-n-pentylphthalate, di-i-pentylphthalate, bis(2-ethylhexyl)phthalate, ethylisobutylphthalate, ethyl-n-butylphthalate, di-n-hexylphthalate, and di-isobutylphthalate.

Examples of diethers that can be used in the step (2) include, but are not limited to: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 1,1-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7-tetrahydroindene, 1,1-bis(methoxymethyl)-7-methylindene, 1,1-bis(methoxymethyl)-1H-benz[e]indene, 1,1-bis(methoxymethyl)-1H-2-methylbenz[e]indene, 9,9-bis(methoxymethyl)fluorene, 9,9-bis(methoxymethyl)-2,3,6,7-tetramethylfluorene, 9,9-bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7-diisopropylfluorene, 9,9-bis(methoxymethyl)-1,8-dichlorofluorene, 9,9-bis(methoxymethyl)-2,7-dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, and 9,9-bis(methoxymethyl)-4-tert-butylfluorene.

Examples of malonates that can be used in the step (2) include, but are not limited to: diethyl2-isopropylmalonate, diethyl2-phenylmalonate, dineopentyl 2-isopropylmalonate, diisobutyl 2-isopropylmalonate, di-n-butyl 2-isopropylmalonate, diethyl 2-dodecylmalonate, diethyl 2-t-butylmalonate, diethyl 2-(2-pentyl)malonate, diethyl 2-cyclohexylmalonate, dineopentyl 2-t-butylmalonate, dineopentyl 2-isobutylmalonate, diethyl 2-cyclohexylmethylmalonate, dimethyl 2-cyclohexylmethylmalonate, diethyl 2,2-dibenzylmalonate, diethyl 2-isobutyl-2-cyclohexylmalonate, dimethyl 2-n-butyl-2-isobutylmalonate, diethyl 2-n-butyl-2-isobutylmalonate, diethyl 2-isopropyl-2-n-butylmalonate, diethyl 2-methyl-2-isopropylmalonate, diethyl 2-isopropyl-2-isobutylmalonate, diethyl 2-methyl-2-isobutylmalonate, diethyl 2-isobutyl-2-benzylmalonate, and diethyldiisobutylmalonate.

Examples of succinates that can be used in the step (2) include, but are not limited to: diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

Examples of esters of aliphatic or aromatic diols that can be used in the step (2) include, but are not limited to: 1,3-propylene-glycol dibenzoate, 2-methyl-1,3-propylene-glycol dibenzoate, 2-ethyl-1,3-propylene-glycol dibenzoate, 2-propyl-1,3-propylene-glycol dibenzoate, 2-butyl-1,3-propylene-glycol dibenzoate, 2,2-dimethyl-1,3-propylene-glycol dibenzoate, (R)-1-phenyl-1,3-propylene-glycol dibenzoate, (S)-1-phenyl-1,3-propylene-glycol dibenzoate, 1,3-diphenyl-1,3-propylene-glycol dibenzoate, 2-methyl-1,3-diphenyl-1,3-propylene-glycol dibenzoate, 1,3-diphenyl-1,3-propylene-glycol dipropionate, 2-methyl-1,3-diphenyl-1,3-propylene-glycol dipropionate, 2,4-pentanediol dibenzoate, 3-methyl-2,4-pentanediol dibenzoate, 3-ethyl-2,4-pentanediol dibenzoate, 3-propyl-2,4-pentanediol dibenzoate, 3-butyl-2,4-pentanediol dibenzoate, 3,3-dimethyl-2,4-pentanediol dibenzoate, (2S,4S)-(+)-2,4-pentanediol dibenzoate, (2R,4R)-(+)-2,4-pentanediol dibenzoate, 2,4-pentanediol di(p-chlorobenzoate), 2,4-pentanediol di(m-chlorobenzoate), 2,4-pentanediol di(p-bromobenzoate), 2,4-pentanediol di(o-bromobenzoate), 2,4-pentanediol di(p-methylbenzoate) 2,4-pentanediol di(p-tert-butylbenzoate), 2,4-pentanediol di(p-butylbenzoate), 2,4-pentanediol dicinnamate, 2-methyl-1,3-pentanediol dibenzoate, 2-methyl-1,3-pentanediol di(p-chlorobenzoate), 2-methyl-1,3-pentanediol di(p-methylbenzoate), 2-butyl-1,3-pentanediol di(p-methylbenzoate), and 2-methyl-1,3-pentanediol di(p-tert-butylbenzoate).

Further, in the step (2), the molar ratio between MgCl₂.xROH and the internal electron donor is preferably between 1 and 50, more preferably preferably between 5 and 20. The molar ratio between said internal electron donor and urea compound is preferably between 0.1 and 100, more preferably between 1 and 10.

During the treatment of the pre-catalyst with a transition metal halide in the step (4), an internal electron donor and/or a urea compound may be added to further improve the catalyst performance, wherein the molar ratio between MgCl₂.xROH and the internal electron donor is preferably between 1 and 50, more preferably between 5 and 20. The molar ratio between said internal electron donor and urea compound is preferably between 0.1 and 100, more preferably between 1 and 10.

The olefin polymerization processes that may be used in accordance with the present invention are not generally limited. The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as prepolymerization, in a hydrocarbon solvent at a temperature of 60° C. or lower for a time sufficient to produce a quantity of polymer from 0.5 to 3 times the weight of the catalyst. If such a prepolymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homopolymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used.

The following analytical methods are used to characterize the polymer.

Heptane Insoluble (HI%): The weight percent (wt %) of residuals of polypropylene sample after extracted with boiling heptane for 8 hours.

Melt Flow Rate (MFR); ASTM D-1238, determined at 230° C. under the load of 2.16 kg.

Molecular weight (Mn and Mw): The weight average molecular weight (Mw), number average molecular weight (Mn), and molecular weight distribution (Mw/Mn) of polymers were obtained by gel permeation chromatography on Water 2000GPCV system using Polymer Labs Plgel 10 um MIXED-B LS 300×7.5 mm columns and 1,2,4-trichlorobenzene (TCB) as mobile phase. The mobile phase was set at 0.9 ml/min, and temperature was set at 145° C. Polymer samples were heated at 150° C. for two hours. Injection volume was 200 microliters. External standard calibration of polystyrene standards was used to calculate the molecular weight.

TiCl₄ (99.9%), anhydrous n-heptane (99%), diisobutyl phthalate (99%), tetramethylurea (99%), and triethylaluminum (93%) were purchased from Sigma-Aldrich Co. of Milwaukee, WI, USA. Diisopropyldimethoxysilane (P-donor) was purchased from Gelest, Inc. of Morrisville, PA, USA. 2-isopropyl-2-(1-methylbutyl)-1,3-dimethoxypropane and microspheroidal MgCl₂.2.9EtOH were kindly provided by Toho Titanium Co. and Xiangyang Chemicals Group, respectively.

Unless otherwise indicated, all reactions were conducted under an inert atmosphere.

### Example 1

### (A) The Preparation of a Solid Catalyst Component (A1)

Into a 500-ml cylindrical glass reactor equipped with a filtering barrier and a stirrer was introduced 250 ml of TiCl₄ at 0° C. While under agitation over a period of 15 minutes, 10 g (43 mmol) of MgCl₂.2.9EtOH was charged into the reactor portion-wise. At the end of addition, the temperature of the reaction mixture was slowly brought to 50° C., and 7 mmol of diisobutyl phthalate and 2 mmol of tetramethylurea were introduced. Then the temperature was increased to 100° C. After 2 hours under agitation, the liquid portion was removed by filtration. Then 250 ml of TiCl₄ was added into the reactor and the reaction mixture was stirred for 1 hour at 115° C. The content was filtered again and another 250 ml of TiCl₄ was added, continuing the treatment for 1 more hour at 115° C. Finally, the content was filtered and washed at 60° C. with 100 ml of n-heptane for 5 times. The solid portion was collected and dried under vacuum at 50° C. to obtain a solid catalyst component (A1).

### (B) Propylene Slurry Polymerization

Propylene polymerization was conducted in a bench scale 2-liter reactor per the following procedure. The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C. 4.3 ml of triethylaluminum (0.58M, in hexanes), 0.4 ml of Diisopropyldimethoxysilane (P-donor) (0.5 M in heptane), and then 30 mg of the solid catalyst component (A1) prepared above were added to the reactor. The temperature of the reactor was kept at 50° C. and 20 psig hydrogen in a 150-ml vessel was flushed into the reactor with propylene.

The reactor temperature was then raised to 70° C. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C. The reactor was then opened. 500 ml methanol was added to the reactor and the resulting mixture was stirred for 5 minutes then filtered to obtain the polymer product. The obtained polymer was vacuum dried at 80° C. for 6 hours. The polymer was evaluated for melt flow rate (MFR), and heptane insoluble (HI%). The activity of catalyst (AC) was also measured.

### Example 2

A solid catalyst component (A2) was prepared in the same manner as in Example 1, except that instead of 7 mmol of diisobutyl phthalate as internal electron donor, 7 mmol of 2-isopropyl-2-(1-methylbutyl)-1,3-dimethoxypropane was added to make catalyst component (A2). Propylene polymerization was carried out in the same manner as described in Example 1, except that solid catalyst component (A2) was charged instead of solid catalyst component (A1) and 8 psig hydrogen instead of 20 psig hydrogen in a 150-ml vessel was flushed into the reactor with propylene.

### Example 3

A solid catalyst component (A3) was prepared in the same manner as in Example 1, except that instead of 7 mmol of diisobutyl phthalate as internal electron donor, 3.5 mmol of 2-isopropyl-2-(1-methylbutyl)-1,3-dimethoxypropane and 3.5 mmol of diethyl 2,3-diisopropyl succinate were added to make catalyst component (A3). Propylene polymerization was carried out in the same manner as described in Example 1, except that solid catalyst component (A3) was charged instead of solid catalyst component (A1).

### Comparative Example 1

### (A) The Preparation of a Solid Catalyst Component (C1)

Into a 500-ml cylindrical glass reactor equipped with a filtering barrier and a stirrer was introduced 250 ml of TiCl₄ at 0° C. While under agitation over a period of 15 minutes, 10 g (43 mmol) of MgCl₂.2.9EtOH was charged into the reactor portion-wise. At the end of addition, the temperature of the reaction mixture was slowly brought to 50° C., and 7 mmol of diisobutyl phthalate was introduced. Then the temperature was increased to 100° C. After 2 hours under agitation, the liquid portion was removed by filtration. Then 250 ml of TiCl₄ was added into the reactor and the reaction mixture was stirred for 1 hour at 115° C. The content was filtered again and another 250 ml of TiCl₄ was added, continuing the treatment for 1 more hour at 115° C. Finally, the content was filtered and washed at 60° C. with n-heptane for 5 times. The solid portion was collected and dried under vacuum at 50° C. to obtain a solid catalyst component (C1).

### (B) Propylene Slurry Polymerization

Propylene polymerization was carried out in the same manner as described in Example 1, except that solid catalyst component (C1) was charged instead of solid catalyst component (A1).

### Comparative Example 2

A solid catalyst component (C2) was prepared in the same manner as in comparative Example 1, except that instead of 7 mmol of diisobutyl phthalate as internal electron donor, 7 mmol of 2-isopropyl-2-(1-methylbutyl)-1,3-dimethoxypropane was added to make catalyst component (C2). Propylene polymerization was carried out in the same manner as described in Example 1, except that solid catalyst component (C2) was charged instead of solid catalyst component (A1) and 8 psig hydrogen instead of 20 psig hydrogen in a 150-ml vessel was flushed into the reactor with propylene.

### Comparative Example 3

A solid catalyst component (C3) was prepared in the same manner as in comparative Example 1, except that instead of 7 mmol of diisobutyl phthalate as internal electron donor, 3.5 mmol of 2-isopropyl-2-(1-methylbutyl)-1,3-dimethoxypropane and 3.5 mmol of diethyl 2,3-diisopropyl succinate were added to make catalyst component (C3). Propylene polymerization was carried out in the same manner as described in Example 1, except that solid catalyst component (C3) was charged instead of solid catalyst component (A1).

TABLE 1
Urea element & internal donor composition
in solid Catalyst Components

| | Catalyst | Internal Donor(s) | Urea element |
|---|---|---|---|
| Example | components | (mmol) | (mmol) |
| Ex. 1 | A1 | DiBP* (7.0) | Tetramethylurea (2.0) |
| Ex. 2 | A2 | Diether** (7.0) | Tetramethylurea (2.0) |
| Ex. 3 | A3 | Diether** (3.5) & | Tetramethylurea (2.0) |
| | | Succinate*** (3.5) | |
| Comp. | C1 | DiBP* (7.0) | None |
| Ex. 1 | | | |
| Comp. | C2 | Diether** (7.0) | None |
| Ex. 2 | | | |
| Comp. | C3 | Diether** (3.5) & | None |
| Ex. 3 | | Succinate*** (3.5) | |

*DiBP = Diisobutyl phthalate
**Diether = 2-isopropyl-2-(1-methylbutyl)-1,3-dimethoxypropane
***Succinate = diethyl 2,3-diisopropyl succinate

TABLE 2
Polymerization Summary

| | | | | | MFR | |
|---|---|---|---|---|---|---|
| | | H₂ | Activity | HI | (g/10 | |
| Example | Catalyst | (psig) | (g/g cat.) | (%) | min) | Mw/Mn |
| Ex. 1 | A1 | 20 | 5347 | 98.2 | 8.5 | 6.2 |
| Comparative | C1 | 20 | 5310 | 97.7 | 9.1 | 6.1 |
| Ex. 1 | | | | | | |
| Ex. 2 | A2 | 8 | 5600 | 98.3 | 4.6 | 5.5 |
| Comparative | C2 | 8 | 5210 | 97.8 | 5.6 | 5.5 |
| Ex. 2 | | | | | | |
| Ex. 3 | A3 | 20 | 6970 | 98.2 | 8.9 | 6.8 |
| Comparative | C3 | 20 | 6634 | 97.2 | 7.4 | 7.2 |
| Ex. 3 | | | | | | |

As shown from the above results, the employment of urea compound as an element of catalyst composition (A1˜A3) in combination with internal donors such as DiBP, Diether and Succinate produce polypropylene with an isotacticity much higher than the comparative catalyst components (C1˜C3) that does not contain urea element in its solid catalyst composition.

As shown in Ex. 1 and Comparative Ex. 1, for a given loading of 7.0 mmol of DIBP as the internal donor, Catalyst component A1 containing urea element in its catalyst composition produced PP with 98.2% HI (Ex.1), which is much higher than 97.7% HI by comparative catalyst component (C1) that does not contain urea element in its solid catalyst composition. As shown in Ex. 2 and Comparative Ex. 2, for a given loading of 7.0 mmol of Diehter as the internal donor, Catalyst component A2 containing urea element in its catalyst composition produced PP with 98.3% HI (Ex.2), which is much higher than 97.8% HI by comparative catalyst component (C2) that does not contain urea element in its solid catalyst composition.

The same trend has been observed in the catalyst systems with mixed internal donors. As shown in Ex. 3 and Comparative Ex. 3, for a given loading of 3.5 mmol of Diether and 3.5 mmol of Succinate as the internal donor, Catalyst component A3 containing urea element in its catalyst composition produced PP with 98.2% HI (Ex.3), which is much higher than 97.2% HI by comparative catalyst component (C3) that does not contain urea element in its solid catalyst composition.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A preparation method for a Ziegler-Natta catalyst for the polymerization of olefins comprising the steps of:
(a) treating MgCl₂.xROH support, wherein x is in the range of from about 1 to about 4 and ROH is an alcohol or a mixture of alcohols where R is a hydrocarbon radical with 1-10 carbon atoms, with a transition metal halide in a reactor at a temperature of between about −30° C. and about 30° C.;
(b) adding one or more internal electron donors and a urea compound at the same or different temperature between about 0° C. and about 100° C., wherein the molar ratio of internal electron donor to urea compound is in the range of about 0.1 to about 100;
wherein the molar ratio between MgCl₂.xROH and the internal electron donor is in the range of about 1 to about 50.

2. The method of claim 1, wherein the urea compound is represented by Formula I: 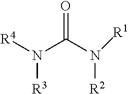
wherein R¹, R², R³, and R⁴, which may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms, wherein two or more of R¹, R², R³, and R⁴ may be linked to form one or more saturated or unsaturated monocyclic or polycyclic rings.

3. The method of claim 1, wherein the one or more internal electron donors are selected from diethers, malonates, succinates, phthalic acid esters, esters of aliphatic or aromatic diols, or their derivatives.

4. The method of claim 1, wherein the treating step occurs at a reaction temperature of between about −10° C. and about 10° C.

5. The method of claim 1, wherein the molar ratio of internal electron donor to urea compound is in the range of about 1 to about 10.

6. The method of claim 1, wherein the molar ratio between MgCl₂.xROH and the internal electron donor is in the range of about 5 to about 20.

7. The method of claim 1, wherein the urea compound is tetramethylurea.

8. The method of claim 1, wherein the one or more electron donors comprises diisobutyl phthalate.

9. The method of claim 1, wherein the one or more electron donors comprises 2-isopropyl-2-(1-methylbutyl)-1,3-dimethoxypropane.

10. The method of claim 1, wherein the one or more electron donors comprises diethyl 2,3-diisopropyl succinate.
